(19) United States
(12) Patent Application Publication
(10) Pub. No.: US 2023/0306339 A1
(43) Pub. Date: Sep. 28, 2023

(54) RISK REDUCTION OPTIMIZATION IN A SMART ENVIRONMENT

(71) Applicant: International Business Machines Corporation, Armonk, NY (US)

(72) Inventors: Venkata Vara Prasad Karri, Visakhapatnam (IN); Sarbajit K. Rakshit, Kolkata (IN); Shailendra Moyal, Pune (IN); Partho Ghosh, Kolkata (IN)

(21) Appl. No.: 17/656,227

(22) Filed: Mar. 24, 2022

(51) Int. Cl. G06Q 10/06; G06N 20/00

(52) U.S. Cl. CPC G06Q 10/0635; G06Q 10/06398; G06Q 10/06316; G06N 20/00

(57) ABSTRACT

A processor may receive worker data associated with a smart environment having one or more workers. The processor may generate a digital twin of the smart environment. The digital twin may be based, at least in part, on the worker data. The processor may simulate the digital twin of the smart environment. The processor may identify, responsive to simulating, a safety score. The safety score may be associated with the one or more workers.

### BACKGROUND

Aspects of the present disclosure relate generally to the field of artificial intelligence, and more particularly to managing workers.

Computing devices and other smart devices have evolved over time to accomplish various tasks for humans, making our lives easier. Such smart devices often link and communicate with other smart devices within an environment (e.g., smart environment). By combining smart devices with AI and machine learning capabilities, smart environments can be configured within user's workplace and home. These smart environments can be configured to perform various services and functions that have changed how humans interact with smart environments. As these devices have grown in popularity, so too have their usefulness and their ability to enhance users' daily experience.

### SUMMARY

Embodiments of the present disclosure include a method, computer program product, and system for risk reduction optimization in a smart environment. A processor may receive worker data associated with a smart environment having one or more workers. The processor may generate a digital twin of the smart environment. The digital twin may be based, at least in part, on the worker data. The processor may simulate the digital twin of the smart environment. The processor may identify, responsive to simulating, a safety score. The safety score may be associated with the one or more workers.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example worker management system, in accordance with aspects of the present disclosure.

FIG. 2 illustrates a flowchart of an example method for optimizing worker safety in a smart environment, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence, and more particularly toward risk reduction optimization in a smart environment. While the present disclosure is not necessarily limited to such applications, various aspects of the disclosure may be appreciated through a discussion of various examples using this context.

The potential hazards associated with various workplace varies dramatically depending on the actions performed within a particular work area and the particular user or users occupying the workspace. Though many workplaces and their conditions may incur little change over time and remain static, other workplaces, by their very nature, have conditions that dynamically change overtime. Depending on the workplace, such conditions may result from changes in weather, changes in equipment conditions (e.g., broken or damaged machine, loss of power, etc.) and changes in the number of people within the environment. While many of these conditions may be benign to employees or users within the workspace, some environmental conditions can negatively impact users. Such negative effects may range in impact level from mere user annoyance to potentially hazardous conditions that result in elevated risk levels to users.

While different workspaces (e.g., industrial floor of a factory or driving a large vehicle) have different levels of risk and chance of accidents, some level of risk can be avoided. Risk levels (e.g., safety score) can often be mitigated or avoided when workers/users take sufficient precautions taken by a worker to avoid possible hazards or accidents (e.g., wear appropriate personal protective equipment and wearable devices), when workplace precautions associated with the health of the machines and mechanical equipment within the workplace are followed, when workers have the appropriate skills needed to perform the various workplace tasks/activities appropriately, and understanding how changes in the workplace environment (e.g., driving a work vehicle during good weather conditions versus bad weather conditions) may affect a worker's performance of a particular task or activity (e.g., contextual environment surroundings).

In workplaces where hazards or the potential for accidents are ignored, workers within the workplace may have their overall safety compromised. Often, it is difficult to remove all risk from a workplace task/activity, particularly when the workplace tasks may be inherently dangerous. As such, a recent addition to the workplace is replacing traditional human workers with robotic workers for tasks that have a safety score that exceeds a safety threshold. As such, there is a desire for a proper distribution of work between human workers and robotic workers, based on an aggregate safety score of a task or activity.

Before turning to the FIGS. it is noted that the benefits/novelties and intricacies of the proposed solution are that:

The system may be configured to receive data from various systems, interpret and classify this data, based at least in part on the operation performed and the type of activity. Activities may be performed by robots and/or humans. The system may be configured to analyze the data and identify various accuracy metrics related to the activity (e.g., using historical data). Using this data, the system may also determine a safety score to associated with a worker's (e.g., human or robot worker) ability to perform the activity safely. Based on these identified accuracy metrics, the system may determine which activities can be performed by a human worker and which activities can be performed by a robotic worker. In some embodiments, the system may identify if the robotic worker or human worker is performing the activity incorrectly.

The system may be configured to perform digital twin simulation of a security score and safety score. The security score and safety score may be determined for each worker and/or may be associated to the machines the worker may interact with while performing activities. Based on the security and safety scores, the system may be configured to assign different activates to different workers to ensure worker safety.

The system may be configured to perform digital twin simulation of the security score (e.g., safety score) to identify what types of precautions and accessories are to be used by the human workers to minimize safety concerns.

Based on the digital twin simulations (e.g., simulations of the safety score, worker equipment/accessories, and activity type), the system may be configured to identify the which accessories are associated with a particular worker and the particular activity type.

While performing the digital twin simulation of the safety score to perform any activity, the system may be configured to identify if a human worker requires additional training to perform an activity. Identification whether additional training is needed may be based on the safety score. The system may then access a database of safety/training materials and provide the human worker the relevant material based on the identified need for additional training.

The system may be configured to collect/receive data over time. This data may include, but is not limited to, data associated with how activities are performed by workers and data associated with workplace accidents and hazards. This data may be stored in a historical repository. The system may use a generative adversarial network model (GAN). The system may then use this information to generate training videos personalized for one or more of the human workers.

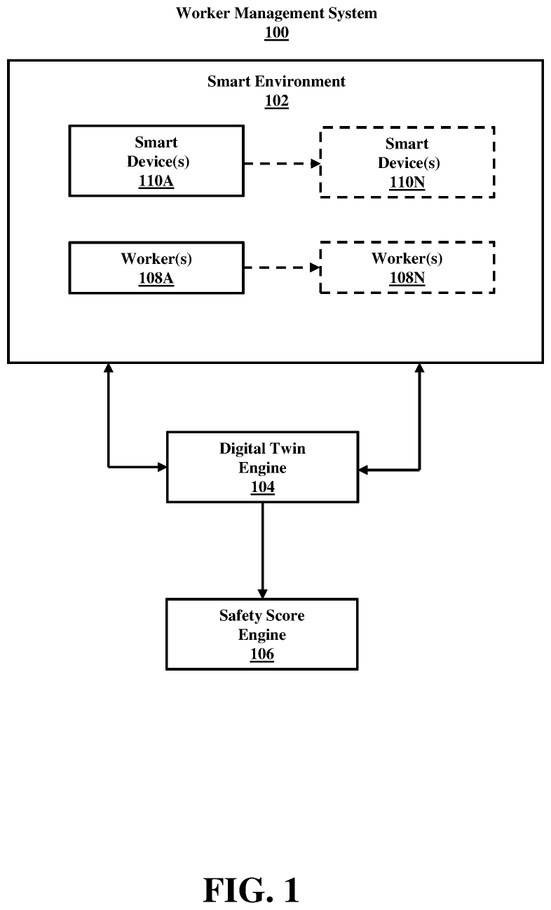

Referring now to FIG. 1, illustrated is a block diagram of an example worker management system 100 for managing workers and reducing worker risk in a smart environment, in accordance with aspects of the present disclosure. for controlling. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

As depicted in FIG. 1, worker management system 100 may be configured to include smart environment 102, digital twin engine 104, and safety score engine 106. Smart environment 102 may include any workplace that may have one or more workers 108A-N, such as a delivery vehicle, a collapsed building site, and an industrial factory floor. One or more workers 108A-N may include human workers and/or robotic workers. In embodiments, the one or more robotic workers may be configured to perform one or more workplace tasks within smart environment 102.

In embodiments, smart environment 102 may further include one or more smart devices 110A-N. In embodiments, worker management system 100 may configure the one or smart devices 110A-N to communicate within a network. The one or more smart devices 110A-N may be configured within and/or around the smart environment 102 to share and provide the worker management system 100 with worker information. In embodiments, a smart environment 102 may include any number or combination of one or more smart devices 110A-N. Smart devices 110A-N may include, but are not limited to devices such as, Internet of Things (IoT) devices, cameras, infrared sensors, ultrasounds, chemical sensors, wearable devices (e.g., device worn into the smart environment by a user), various types of smart device (e.g., AI assistant devices), or any combination thereof. In embodiments, worker management system 100 may configured smart devices 110A-N to receive/collect worker information in real-time and/or to collect worker information over a particular time duration. Such worker information may be stored in a historical repository and accessed as needed by worker management system 100 by digital twin engine 104 (e.g., when using AI and machine learning capabilities performing simulations/analyses contemplated herein). While some smart devices 110A-N may be configured within the smart environment, other data collection devices may be configured outside and/or around the smart environment. For example, some smart devices 110A-N may be wearable devices configured on a worker (e.g., human worker and/or robotic worker), while other smart devices 110A-N may be positioned throughout the smart environment (e.g., at the entrance of the smart environment) to collect worker information associated with the user/worker.

In embodiments, worker information may include any data or information associated with the smart environment and managing one or more workers 108A-N in the smart environment. For example, worker information may include any data derived from the smart environment (e.g., workplace), and data associated with all or less than all of the workers (e.g., human workers and robotic workers) intending to perform one or more workplace tasks/activities within the smart environment. Worker information may include, but is not limited to: i) the configuration of smart environment 102 (e.g., workplace layout and/or dimensions); ii) what objects (e.g., machine, equipment, chemicals, etc.) may be currently occupying smart environment 102; iii) location of each object (e.g., real-time location) within smart environment 102; iv) user/worker activity within smart environment 102, such as how the workers (e.g., (e.g., one or more workers 108A-N) perform workplace tasks in smart environment 102 (e.g., potential problems or accidents, equipment use, user actions, etc.); v) information/data generated from various analyses contemplated herein (e.g., information/data generated by AI and machine learning analysis); vi), databases having information/data associated with the same or similar smart environments (e.g., common environment conditions, such as hazards that may transpire among similarly configured smart environments); vii) worker skills (e.g., human abilities and/or robot specifications), types and capabilities of the equipment (e.g., machines and accessories) in smart environment 102, types of personal protective equipment); and viii), current status of the equipment (e.g., is the machine overheating). In some embodiments, worker management system 100 may also receive worker information from one or more databases. These one or more databased may include worker information associated with the human workers, the human worker skills, types of machines in smart environment 102, types of accessories in the smart environment, and the configuration of the machines and/or equipment in smart environment 102.

In embodiments, worker management system 100 may be configured to store worker information collected over time in a historical repository. The historical repository may include any worker information contemplated herein, such as data/information associated with the one or more users/workers and/or various user/worker activity (e.g., worker communications, worker actions within smart environment 102, work related workplace tasks/activities, etc.) performed within smart environment 102. In embodiments, worker management system 100 may access the historical repository to generate one or more digital twins using AI and machine learning capabilities (e.g., digital twin engine 104). The information generated from these analyses may be considered worker information and may also be stored within the historical repository.

In one example embodiment, worker management system 100 may be configured to manage the workers associated with a collapsed building area (e.g., smart environment 102). Collapsed building area may have workers, both human workers and robotic workers, performing one or more workplace tasks, such as clearing building debris. In some embodiments, one or more smart devices 110A-N may be configured throughout the collapsed building area. While some smart devices 110A-N may be configured on or around human workers (e.g., wearable devices), in other embodiments, some smart devices 110A-N may be configured within one or more robotic workers.

In embodiments, worker management system 100 may configure digital twin engine 104 to generate one or more digital twins associated with smart environment 102 using digital twin engine 104 (e.g., using artificial intelligence and machine learning capabilities). The worker management system 100 may base the one or more digital twins on worker information collected in real-time and/or collected from the historical repository. In embodiments, worker management system 100 may be configured to simulate each of the one or more workers 108A-N (e.g., human workers and robotic workers), identify the one or more workplace tasks/activities each of the one or more workers 108A-N intends to perform and/or is currently performing, determine the skill level associated with each of the one or more workers 108A-N (e.g., human workers have specialized building construction training), and whether the human workers are adhering to one or more precautions. In some embodiments, worker management system 100 may uniquely identify each piece of equipment and/or machine configured within smart environment 102. In some embodiments, each piece of equipment and/or machine may be identified with a unique security key. In these embodiments, worker management system 100 may generate a digital twin for each piece of equipment and/or machine in smart environment 102.

Worker management system 100, using digital twin engine 104, may generate one or more simulations. Using these one or more simulations, worker management system 100 may use safety score engine 106 to generate a safety score associated with smart environment 102 and one or more workplace tasks to be performed by one or more workers 108A-N (e.g., human workers and/or robotic workers). In these embodiments, worker management system may use the simulations and historical worker information to identify the types of workplace tasks and activities are being performed and associated machines used to perform the workplace tasks and activities in smart environment 102, whether the worker is performing the task or activity with a sufficient level of skill, and one or more precautions and associated accessories the workers may be taking to mitigate risk (e.g., whether workers are wearing personal protective equipment). In embodiments, worker management system 100 may be configured to identify different context activity associated with smart environment 102 (e.g., using digital twin engine and historical learning).

In embodiments, worker management system 100 may configure safety score engine 106 to receive data/information associated with the various digital twins and simulations contemplated herein. In some embodiments, safety score engine 106 may also be configured to receive worker information associated with a variety of parameters. For example, safety score engine 106 may use worker information such as the probability of worker hazard, types of worker hazards, if the hazard could be avoided with a precaution, and how much the precaution will mitigate the hazard. Using this data/information (e.g., a type of worker information) management system 100 may use safety score engine to generate a safety score for each worker and/or task/activity the worker is intending to perform. In embodiments, a higher safety score indicates a higher risk associated with the worker and task and a lower safety score indicates a lower level of risk or fewer associated hazards.

In embodiments, worker management system 100 may be configured to determine whether the safety score associated with the one or more workers 108A-N (e.g., a worker performing a particular task or activity) activates a safety threshold. In some embodiments, the safety threshold may be determined by a security policy or may be determined by an administrator to worker management system 100. In some embodiments, the security policy may be configured by the administrator or manager of smart environment 102.

In embodiments, worker management system 100 may compare the safety score generated for the particular worker (e.g., worker 108A) and associated task or activity to the safety threshold. In embodiments where worker management system 100 determines a worker's safety score does not activate the safety threshold, worker management system 100 may identify the worker as an approved worker. In these embodiments, worker management system 100 may enable or grant the approved worker permission to perform the one or more workplace tasks in smart environment 102. For example, worker management system 100 may determine that a worker using a milling machine has a safety score that indicates the worker is performing the milling (e.g., workplace task) in a safe manner without creating a hazard to the worker or others around the worker. As such, worker management system 100 may determine the worker's safety score does not activate a safety threshold and the worker is an approved worker. In such embodiments, the worker will be granted permission to perform or continue performing the milling or workplace task (e.g., via notification to a mobile device).

In some embodiments, worker management system 100 may determine that a worker's safety score activates the safety threshold. In these embodiments, worker management system 100 may identify the worker (e.g., a worker of the one or more workers 108A-N) as an unapproved worker. In these embodiments, worker management system 100 may prevent the unapproved worker from performing the one or more workplace tasks/activities. For example, worker management system 100 may issue the unapproved worker a notification (e.g., via mobile device) indicating that the unapproved worker should not perform or should cease performing the workplace task.

In some embodiments, worker management system 100 may be configured to analyze worker information (e.g., historical worker information) from the historical repository and use this information to determine if the safety score associated with the unapproved worker and workplace task could be reduced to an amount that would not activate the safety threshold, were the worker to undergo additional training (e.g., one or more training activities). In such embodiments, worker management system 100 may be configured to identify what types of one or more training activities should be required by the unapproved worker to reduce their safety score. In some embodiments, worker management system 100 may use historical worker information (e.g., using GAN) to create one or more appropriate training activities (e.g., training videos for a worker). In such embodiment, once an unapproved worker has performed the one or more training activities, worker management system 100 may be configured to reevaluate or reanalyze the unapproved worker to determine if their safety score has been reduced to a level that does not activate the safety threshold, worker management system 100 may identify the previously identified unapproved worker as an approved worker.

In such embodiments, worker management system 100 may assign the one or more workplace tasks previously assigned to the now identified unapproved worker to a robotic worker. For example, in embodiments where worker management system 100 determines that one or more workplace tasks have too high of risk (e.g., a safety score that activates that safety threshold), worker management system 100 may be configured to prevent the worker (e.g., unapproved worker) from performing the workplace task and instead assign a non-human device, such as a robotic worker (e.g., robot module), to perform the workplace task. In such embodiments, the level of risk associated with the workplace task's elevated safety score would be assumed by the robotic worker and not the human worker. In some embodiments, worker management system 100 may be configured to identify all of the human workers and robotic workers (e.g., one or more workers 108A-N) and their various abilities/skills associated with smart environment 102 that may be utilized to perform one or more workplace tasks.

In embodiments, worker management system 100 may be configured to identify (e.g., using digital twin engine 104 and/or safety score engine 106) one or more precautions associated with a reduced safety score, wherein the reduced safety score is less than the safety threshold. For example, worker management system 100 may analyze worker information and determine if a precaution, such as requiring the one or more workers 108A-N to wear helmets and other personal protective equipment during specific workplace tasks would reduce the worker's safety score (e.g., mitigate the level of risk or hazards) enough to ensure the safety threshold is not activated (e.g., does not require a robotic worker to take the place of the human worker).

In some embodiments, worker management system 100 may be configured to use digital twin engine 104 to identify a safety score (e.g., safety score engine 106) associated with one or more configurations of machinery/equipment within smart environment 102. Based on the identified safety score, worker management system may determine if the one or more configurations of machinery/equipment within smart environment 102 creates a possible hazard or level of risk that activates the safety threshold. While in some embodiments, worker management system 100 may determine at the one or more configurations of machinery/equipment in smart environment 102 do not activate the safety threshold, in other embodiments, worker management system 100 may determine the safety threshold is activated.

In embodiments where worker management system 100 determines that the safety threshold is activated because of the configuration of machinery/equipment, worker management system 100 may generate one or more recommended configurations of machinery/equipment with associated safety scores that do not activate the safety threshold using one or more simulations (e.g., generated using digital twin engine 104). For example, worker management system 100 may be configured to receive worker information indicating the position of machine A and machine B within smart environment 102. Worker management system 100 may determine that machine A and machine B in these positions result in a safety score that activates the safety threshold. Using digital twin engine 104 and safety score engine 106, worker management system 100 may identify one or more recommended configurations or positions within smart environment 102 where machine A and machine B may be placed without activating the safety threshold.

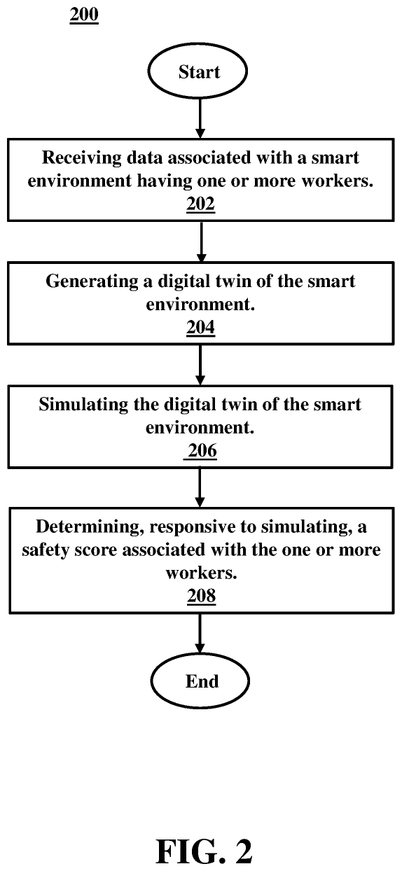

Referring now to FIG. 2, a flowchart illustrating an example method 200 for optimizing risk reduction in a smart environment, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where a processor may receive worker information associated with a smart environment having one or more workers. In some embodiments, the method 200 proceeds to operation 204.

At operation 204, a processor may generate a digital twin of the smart environment. In some embodiments, the digital twin may be based, at least in part, on the worker information. In some embodiments, the method 200 proceeds to operation 206.

At operation 206, a processor may simulate the digital twin of the smart environment. In some embodiments, the method 200 proceeds to operation 208.

At operation 208, a processor may identify, responsive to simulating, the safety score associated with the one or more workers. In some embodiments, as depicted in FIG. 2, after operation 208, the method 200 may end.

In some embodiments, discussed below, there are one or more operations of the method 200 not depicted for the sake of brevity and which are discussed throughout this disclosure. Accordingly, in some embodiments, the processor determine the safety score associated with the one or more workers activates a safety threshold. In such embodiments, responsive to the safety score activating the safety threshold, the processor may identify that a worker of the one or more workers is an unapproved worker. The processor may then prevent the unapproved worker from performing one or more workplace tasks. In some embodiments, the processor may prompt the unapproved worker to perform one or more training activities. In embodiments where the processor identifies the worker as an unapproved worker, the processor may assign an approved worker the one or more workplace tasks. In some embodiments, the approved worker may be a robot module.

In some embodiments, the processor may determine that the safety score associated with a worker of the one or more workers does not activates a safety threshold. In these embodiments, the processor may identify that the worker is an approved worker. In embodiments where the processor has identified the worker as an approved worker, the processor may grant the approved worker permission to perform the one or more workplace tasks in the smart environment. In some embodiments, the processor may identify one or more precautions associated with a reduced safety score, wherein the reduced safety score is less than the safety threshold.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

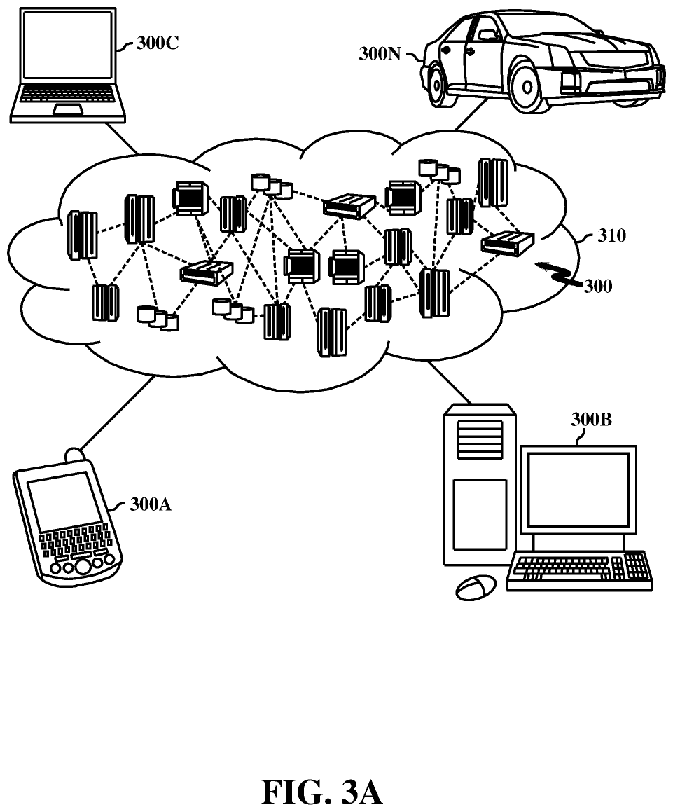

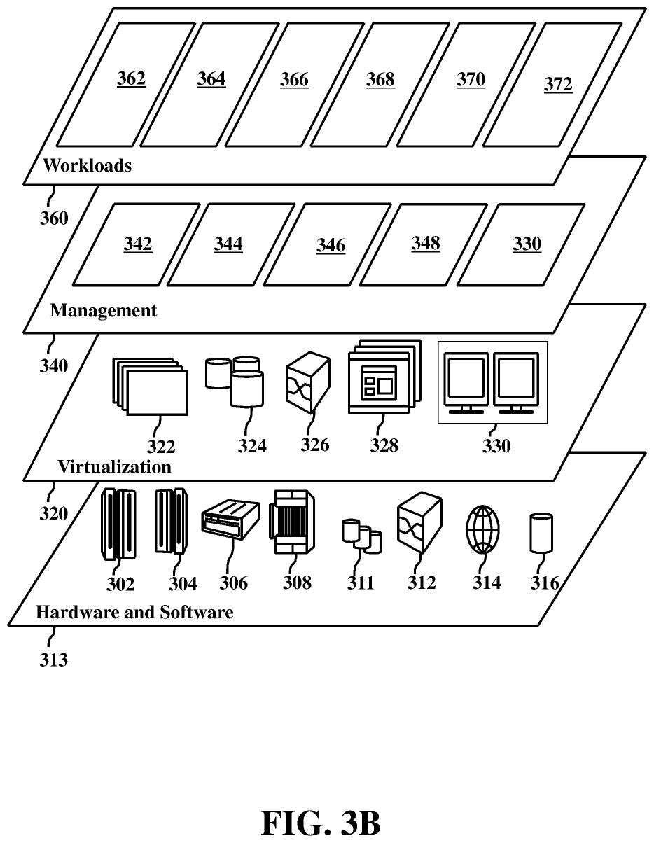

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and optimizing risk reduction 372.

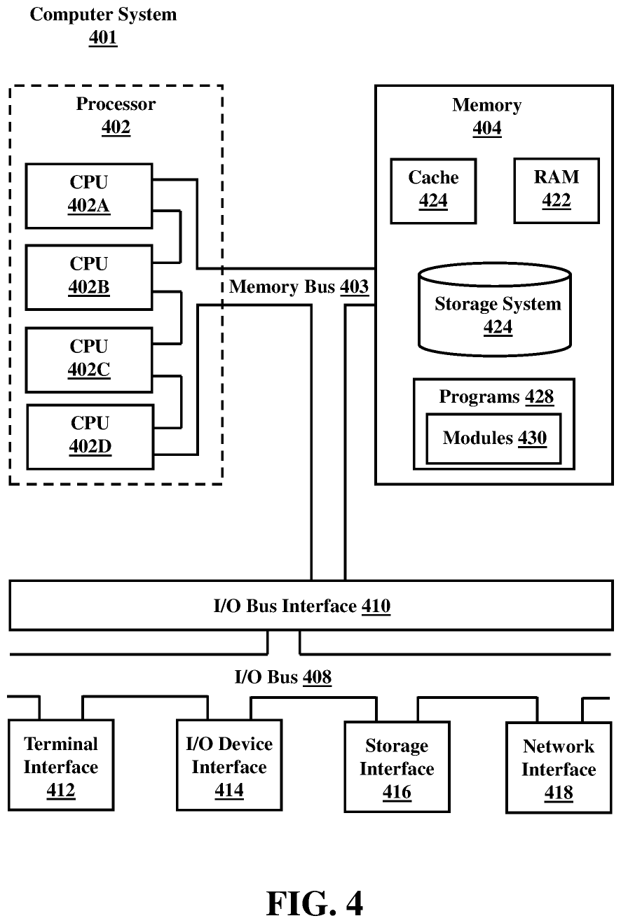

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, worker information associated with a smart environment having one or more workers;
generating a digital twin of the smart environment, wherein the digital twin is based, at least in part, on the worker information;
simulating the digital twin of the smart environment; and
identifying, responsive to simulating, a safety score associated with the one or more workers.

2. The method of claim 1, further comprising:
determining the safety score associated with the one or more workers activates a safety threshold.

3. The method of claim 2, further including:
identifying that, responsive to the safety score activating the safety threshold, a worker of the one or more workers as an unapproved worker; and
preventing the unapproved worker from performing one or more workplace tasks.

4. The method of claim 3, further including:
prompting the unapproved worker to perform one or more training activities.

5. The method of claim 3, further including:
assigning an approved worker the one or more workplace tasks, wherein the approved worker is a robot module.

6. The method of claim 1, further comprising:
determining that the safety score associated with a worker of the one or more workers does not activates a safety threshold;
identifying that, responsive to determining the safety score does not activate a safety threshold, the worker is an approved worker; and
granting the approved worker permission to perform the one or more workplace tasks in the smart environment.

7. The method of claim 1, further comprising:
identifying one or more precautions associated with a reduced safety score, wherein the reduced safety score is less than the safety threshold.

8. A system, the system comprising:
a memory; and
a processor in communication with the memory, the processor being configured to perform operations comprising:
receiving worker information associated with a smart environment having one or more workers;
generating a digital twin of the smart environment, wherein the digital twin is based, at least in part, on the worker information;
simulating the digital twin of the smart environment; and
identifying, responsive to simulating, a safety score associated with the one or more workers.

9. The system of claim 8, further comprising:
determining the safety score associated with the one or more workers activates a safety threshold.

10. The system of claim 9, further including:
identifying that, responsive to the safety score activating the safety threshold, a worker of the one or more workers is an unapproved worker; and
preventing the unapproved worker from performing one or more workplace tasks.

11. The system of claim 10, further including:
prompting the unapproved worker to perform one or more training activities.

12. The system of claim 10, further including:
assigning an approved worker the one or more workplace tasks, wherein the approved worker is a robot module.

13. The system of claim 8, further comprising:
determining that the safety score associated with a worker of the one or more workers does not activates a safety threshold;
identifying that, responsive to determining the safety score does not activate a safety threshold, the worker is an approved worker; and
granting the approved worker permission to perform the one or more workplace tasks in the smart environment.

14. The system of claim 8, further comprising:
identifying one or more precautions associated with a reduced safety score, wherein the reduced safety score is less than the safety threshold.

15. A computer program product comprising a computer readable storage medium having program instructions embodied therewith, the program instructions executable by a processor to cause the processor to perform operations, the operations comprising:
receiving worker information associated with a smart environment having one or more workers;
generating a digital twin of the smart environment, wherein the digital twin is based, at least in part, on the worker information;
simulating the digital twin of the smart environment; and
identifying, responsive to simulating, a safety score associated with the one or more workers.

16. The computer program product of claim 15, further comprising:
determining the safety score associated with the one or more workers activates a safety threshold.

17. The computer program product of claim 16, further including:
identifying that, responsive to the safety score activating the safety threshold, a worker of the one or more workers is an unapproved worker; and
preventing the unapproved worker from performing one or more workplace tasks.

18. The computer program product of claim 17, further including:
prompting the unapproved worker to perform one or more training activities.

19. The computer program product of claim 17, further including:
assigning an approved worker the one or more workplace tasks, wherein the approved worker is a robot module.

20. The computer program product of claim 15, further comprising:
determining that the safety score associated with a worker of the one or more workers does not activates a safety threshold;
identifying that, responsive to determining the safety score does not activate a safety threshold, the worker is an approved worker; and
granting the approved worker permission to perform the one or more workplace tasks in the smart environment.
